(19) United States
(12) Patent Application Publication
(10) Pub. No.: US 2024/0344844 A1
(43) Pub. Date: Oct. 17, 2024

(54) SYSTEM AND METHOD FOR RECOMMENDING ALTERNATIVE CONTENT BASED ON VEHICLE SITUATION RECOGNITION

(71) Applicant: LOYQU Inc., Seoul (KR)

(72) Inventor: GOYA CHOI, Gimpo-si (KR)

(21) Appl. No.: 18/222,407

(22) Filed: Jul. 14, 2023

(30) Foreign Application Priority Data
Apr. 12, 2023 (KR) 10-2023-0048299

(51) Int. Cl. G01C 21/36; G01C 21/34

(52) U.S. Cl. CPC G01C 21/3697; G01C 21/3476; G01C 21/3484

(57) ABSTRACT

The system of the present disclosure comprises a user terminal configured to provide user data and vehicle movement route data, a vehicle terminal configured to provide vehicle sensor data, a POI data and content providing server configured to recommend POI data and/or other content that is related to at least one of the user data and vehicle movement route data provided from the user terminal, and the vehicle sensor data provided from the vehicle terminal, and web data collected from a web server, or based on the location, and recognize the vehicle situation according to changes in at least one of the user data, the vehicle movement route data such as destination, the vehicle sensor data, and the web data to re-recommend alternative POI data and/or other contents that are associated with at least one of changed data, and the user terminal is interlocked with the vehicle terminal.

### CROSS-REFERENCE TO RELATED APPLICATION(S)

This application claims priority to Korean Patent Application No. 10-2023-0048299 filed in the Korean Intellectual Property Office on Apr. 12, 2023, the disclosure of which is incorporated by reference herein in its entirety.

### TECHNICAL FIELD

The present disclosure relates to a system and method for recommending alternative content based on vehicle situation recognition.

### DISCUSSION OF RELATED ART

With the recent improvement in living standards, vehicle culture has become commonplace, and passengers spend more and more time staying inside the vehicle due to long-distance driving or traffic jams. Accordingly, various convenience facilities and convenience services are provided inside the vehicle for the convenience of passengers staying inside the vehicle for a long time.

As a representative example of such convenience services, there is a telematics service. The term “telematics” is a combination of telecommunication and informatics, which is defined as a next-generation information provision service for automobiles through the combination of the IT industry and the automobile industry, in which wireless communication, automobiles, terminals, and contents are organically related to each other.

A conventional telematics service may provide various services such as traffic and driving information, emergency response information, remote vehicle diagnosis service, Internet, e-mail, life information, and entertainment through the in-vehicle device by utilizing wireless communication technology and global positioning system (GPS) technology,

As contents that can be consumed while driving diversify, there is a trend of expanding into an integrated vehicle platform such as providing contents such as music and radio while driving.

Accordingly, there is a demand for technology for recommending various contents according to vehicle situations in the present technical field.

### SUMMARY

An object of the present disclosure is to provide a system and method for recommending alternative content based on vehicle situation recognition that may address conventional issues.

The system for recommending alternative content based on vehicle situation recognition according to the present disclosure comprises a user terminal configured to provide user data and vehicle movement route data, a vehicle terminal configured to provide vehicle sensor data, a point of interest (POI) data and content providing server configured to recommend POI data and/or other content such as videos, music, and images, that is related to or location-based on at least one of the user data and vehicle movement route data provided from the user terminal, and the vehicle sensor data provided from the vehicle terminal, and web data collected from a web server, and recognize the vehicle situation according to changes in at least one of the user data, the vehicle movement route data such as destination, the vehicle sensor data, and the web data to re-recommend alternative POI data and/or other contents such as videos, music, and images, that is associated with at least one of changed data, and the user terminal is interlocked or mounted in the vehicle terminal.

The method for recommending alternative content based on vehicle situation recognition according to the present disclosure comprises collecting user data and vehicle movement route data from a user terminal, vehicle sensor data from a vehicle terminal, and web data from a web server, modeling the user data, the vehicle sensor data, the web data, and movement route data collected from a POI data and content providing server, recommending POI data and other contents such as videos, music, and images suitable for the vehicle movement route data such as destination and user data, determining or recognizing the vehicle situation in real-time based on the modeling data, and searching for and re-commending alternative POI data and/or other contents such as videos, music, and images to replace the POI data and/or other contents such as videos, music, and images when the vehicle situation changes.

The system and method for recommending alternative content based on vehicle situation recognition according to an embodiment of the present disclosure provides customized POI data and/or other contents such as videos, images, and music according to the vehicle situation, such as the location, direction, destination, and movement speed of the vehicle, thereby having the advantage of being able to recommend customized alternative content according to the real-time changing vehicle movement situation and external variables.

### BRIEF DESCRIPTION OF THE DRAWINGS

A more complete appreciation of the present disclosure and many of the attendant aspects

thereof will be readily obtained as the same becomes better understood by reference to the following detailed description when considered in connection with the accompanying drawings, wherein:

FIG. 1 is a network configuration diagram of a system for supporting an alternative content recommendation service based on vehicle situation recognition according to an embodiment of the present disclosure;

FIG. 2 is a device configuration diagram of a vehicle terminal shown in FIG. 1;

FIG. 3 is a detailed configuration diagram of the POI data and content providing server shown in FIG. 1;

FIG. 4 is a detailed configuration diagram of the data modeling unit shown in FIG. 3;

FIGS. 5 and 6 are diagrams illustrating situations in which POI data and other contents such as videos, music, and images are recommended as alternative POI data and/or other contents such as videos, music, and images according to vehicle situation; and

FIG. 7 is a flowchart illustrating a system for supporting service for recommending content based on vehicle situation recognition according to an embodiment of the present disclosure.

### DETAILED DESCRIPTION OF EXEMPLARY EMBODIMENTS

Hereinafter, with reference to the accompanying drawings, embodiments of the present disclosure will be described in detail so that those skilled in the art can easily carry out the present disclosure. However, the present disclosure may be embodied in many different forms and is not limited to the embodiments described herein. In order to clearly describe the present disclosure in the drawings, parts irrelevant to the description are excluded, and similar reference numerals are assigned to similar parts throughout the specification.

Throughout the specification, when a part is said to be “connected” to another part, this includes not only the case of being “directly connected” but also the case of being “electrically connected” with another part in between. Further, it should be understood that when a part “includes” a certain component, this means that it may further include other components, not excluding other components, unless otherwise stated, and the presence or addition of one or more other features, numbers, steps, operations, components, parts, or combinations thereof is not precluded.

As used throughout the specification, the terms of degrees such as “about,” “substantially,” etc., are used in the meaning of a referenced value at or close to that value when inherent manufacturing and material tolerances are given, and they are used to prevent undue exploitation of the disclosure in which exact or absolute figures are recited to aid in the understanding of the present disclosure by unscrupulous infringers. The term “step of (doing)” or “step of” used throughout the specification of the present disclosure does not mean “step for.”

In this specification, the term “unit” includes a unit realized by hardware, a unit realized by software, and a unit realized using both. Further, one unit may be realized using two or more hardware, and two or more units may be realized by one hardware. Meanwhile, the term ‘unit’ is not limited to software or hardware, and ‘unit’ may be configured to be in an addressable storage medium or configured to reproduce one or more processors. Thus, as an example, ‘unit’ includes components such as software components, object-oriented software components, class components, and task components, processes, functions, properties, procedures. subroutines, segments of program code, drivers, firmware, microcode, circuitry, data, databases, data structures, tables, arrays and variables. Functions provided within components and ‘˜units’ may be combined into smaller numbers of components and ‘unit’ or further separated into additional components and ‘unit.’ In addition, components and ‘unit’ may be implemented to play one or more CPUs in a device or a secure multimedia card.

In this specification, some of the operations or functions described as being performed by a terminal, apparatus, or device may be performed instead by a server connected to the terminal, apparatus, or device. Likewise, some of the operations or functions described as being performed by the server may also be performed by a terminal, apparatus, or device connected to the server.

In this specification, some of the operations or functions described as mapping or matching with the terminal may be interpreted as meaning mapping or matching with the terminal's unique number or personal identification information, which is identifying data of a terminal.

Hereinafter, a system and method for supporting an alternative content recommendation service based on vehicle situation recognition according to an embodiment of the present disclosure will be described in more detail based on the accompanying drawings.

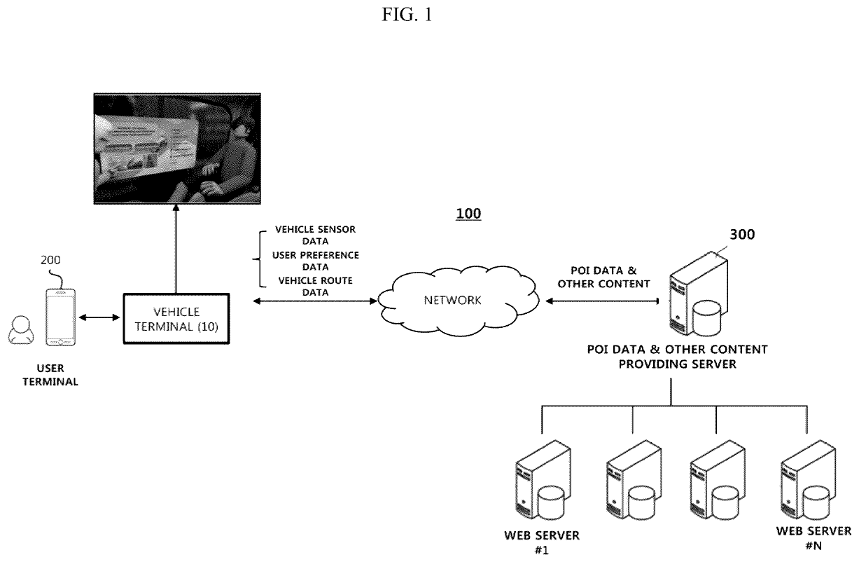

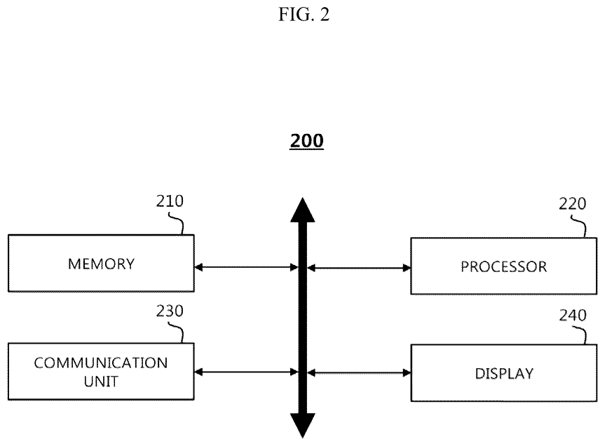

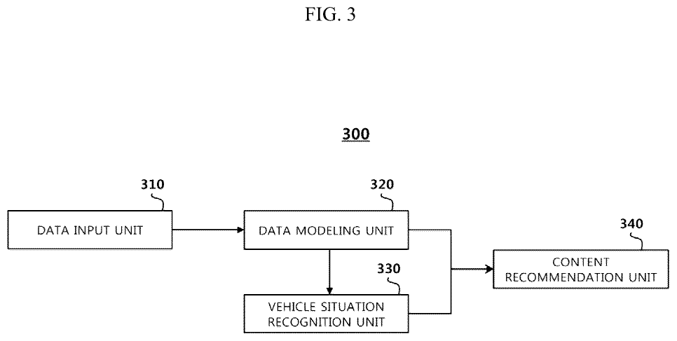

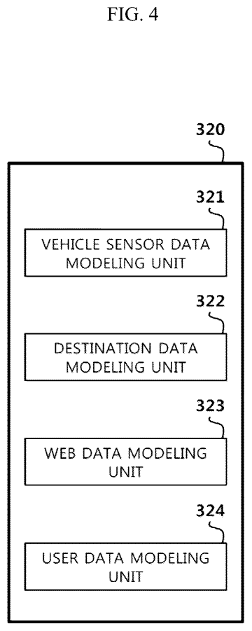

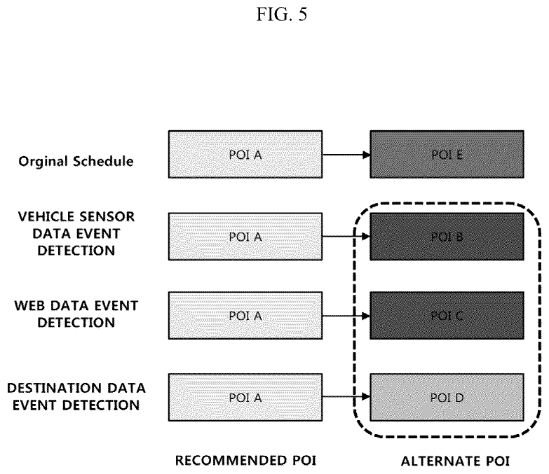

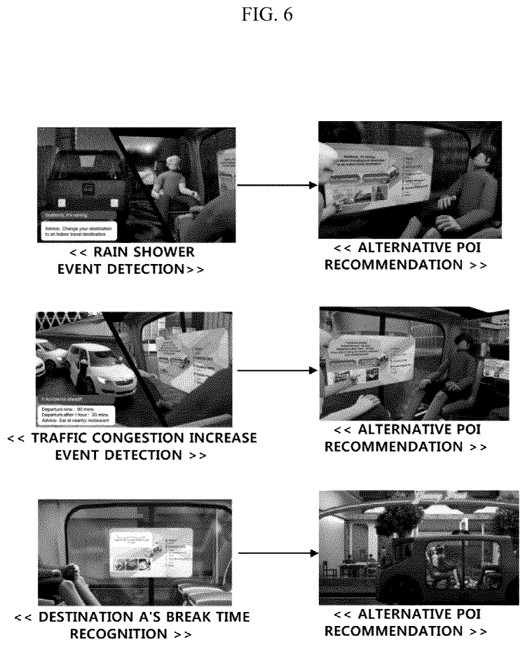

FIG. 1 is a network configuration diagram of a system for supporting an alternative content recommendation service based on vehicle situation recognition according to an embodiment of the present disclosure, FIG. 2 is a device configuration diagram of a vehicle terminal shown in FIG. 1, FIG. 3 is a detailed configuration diagram of the POI data and content providing server shown in FIG. 1, FIG. 4 is a detailed configuration diagram of the data modeling unit shown in FIG. 3, and FIGS. 5 and 6 are diagrams illustrating situations in which POI data and other contents such as videos, music, and images are recommended as alternative POI data and/or other contents such as videos, music, and images according to vehicle situation.

As shown in FIG. 1, a system for supporting an alternative content recommendation service based on vehicle situation recognition 100 according to an embodiment of the present disclosure, comprises a vehicle terminal 10, a user terminal 200, and POI data and content server 300.

Each component communicates over a network. A network refers to a connection structure capable of exchanging information between nodes such as a plurality of terminals and servers. Examples of such networks include radio frequency (RF), 3rd generation partnership project (3GPP) network, long term Evolution (LTE) network, 5th generation partnership project (5GPP) network, world interoperability for microwave access (WiMAX) network, Internet, local area network (LAN), wireless local area network (wireless LAN), wide area network (WAN), personal area network (PAN), Bluetooth network, near field communication (NFC) network, satellite broadcasting network, analog broadcasting network, digital multimedia broadcasting (DMB) network, 5G network, 6G network, etc., but are not limited thereto.

It will be clear that in the following, the term “at least one” is defined as a term including singular and plural, and even if the term “at least one” does not exist, each component may be present in singular or plural, and it can mean singular or plural. Further, each component is provided in singular or plural, which can be changed according to the embodiment.

The vehicle terminal 10 may be configured to collect and display vehicle state information related to the external environment and internal environment of the vehicle measured by each sensor installed in the vehicle. Each sensor may include at least one raindrop sensor, a temperature sensor, an acceleration sensor, a sound sensor, an anti-lock brake system (ABS) motion sensor, and GPS.

The user terminal 200 may be configured to provide user data related to the occupant and vehicle movement route data.

Further, the user terminal 200 may be interlocked or mirrored with the vehicle terminal 10 and receive vehicle sensing data sensed from the vehicle terminal 10, which is sensed by the vehicle terminal 10 and provide vehicle sensing data to the POI data and content providing server 300 described later.

Preferably, the user terminal 200 and the vehicle terminal 10 may be the same or different, and if they are the same, the user terminal 200 may be mounted in the vehicle terminal 10.

The user terminal 200 may provide user data related to the occupant and movement route data and may be a terminal that executes POI data and/or other contents such as videos, music, and images or alternative POI data and/or other contents such as videos, music, and images according to vehicle situation provided from the POI data and content providing server 300.

Further, the user terminal 200 may be configured to provide response information to a questionnaire for investigating the user's content preference and content consumption tendency requested by the POI data and content providing server 300.

Meanwhile, the user terminal 200 may include a memory 210, a processor 220, a communication unit 230 and a display 240. The memory 210 may store the instructions of the processor 220. Specifically, the instructions may be codes generated for the purpose of causing the terminal 200 to function in a specific way and may be stored in computer-usable or computer-readable memory that may be directed to a computer or other programmable data processing equipment. Instructions may perform processes for executing functions described in the specification of the present disclosure.

The processor 220 may include a hardware configuration such as a micro-processing unit (MPU), a central processing unit (CPU), a cache memory, and a data bus. It may further include an operating system and a software configuration of an application that performs a specific purpose.

The communication unit 230 may transmit and receive the necessary information to and from the vehicle terminal 10 and the POI data and content providing server 300 and may transmit and receive information through vehicle-to-everything (V2X) communication using wireless access in vehicular environment (WAVE) known as vehicle wireless communication (IEEE 802.11p), but it is not limited thereto.

The display 240 may be configured to display recommended content or alternative content provided internally and externally and display various contents. For example, various menus screen are displayed using a user interface stored in the memory 210 and/or a graphic user interface under the control of the processor 220.

Here, the content displayed on the display 240 may include various text or image data, video data, web data, and the like, and the display 240 may be a touch screen.

Further, the display 240 may include at least one of a flexible display, a 3D display, an e-ink display, and a light emitting diode (LED).

Next, the POI data and content providing server 300 may be configured to recommend POI data and/or other contents such as videos, music, and images related to or location-based on at least one of the user data and vehicle movement route data provided from the user terminal 200, vehicle sensor data provided from the vehicle terminal, and web data collected from the web server and may be configured to re-recommend alternative POI data and/or other contents such as videos, music, and images related to at least one of the changed data or searched based on at least one of the changed data by recognizing the vehicle situation according to the change of at least one of the user data, vehicle route such as destination data, vehicle sensor data, and web data.

The POI data and content providing server 300 may be configured to collect and model vehicle sensor data.

The POI data and content providing server 300 may be configured to collect basic information and feature information related to a destination in the vehicle route data and perform data modeling.

The POI data and content providing server 300 may be configured to collect web data, including at least one of weather, traffic conditions such as traffic congestion, local specialties, stores, and local events in a region corresponding to a movement route of the vehicle to perform data modeling.

The POI data and content providing server 300 may be configured to model user data for analyzing individual user preferences based on the user data received from the user terminal.

The POI data and content providing server 300 may be configured to recognize the vehicle situation in real-time based on vehicle sensor data, web data, and destination data and recommend alternative content that matches or is related to the user data and destination data whenever the vehicle situation changes.

More specifically, the POI data and content providing server 300 may comprise a data input unit 310, a data modeling unit 320, a vehicle situation recognition unit 330, and a content recommendation unit 340.

The data input unit 310 may be configured to receive user data, vehicle route (origin to stop to destination) data, and vehicle sensor data provided by the terminal 200.

The data modeling unit 320 may be configured to model vehicle sensor data, destination data within a vehicle route, web data, and user data.

More specifically, the data modeling unit 320 may comprise a vehicle sensor data modeling unit 321, a destination data modeling unit 322, a web data modeling unit 323, and a user data modeling unit 324.

The vehicle sensor data modeling unit 321 may be a part that collects and manages vehicle sensor data and manage the vehicle's sensor data information such as GPS information, wheel speed, rain sensor, and direction. The vehicle sensor data modeling unit 321 may perform functions such as data collection, monitoring, and processing.

The destination data modeling unit 322 may be a part that analyzes destination information, and the information may include basic information such as contact information, location and operating hours, and other feature information related to terrace, swimming pool, sunrise and sunset attractions, and indoor and outdoor. The destination data modeling unit 322 may perform functions such as creating, modifying, and deleting POI data.

The web data modeling unit 323 may be a part that models data collected through the web, and the web data collected by the web data modeling unit 323 may act as an element for recognizing vehicle situations. The web data may include data such as weather data, traffic conditions, and congestion, and the corresponding data may be obtained in the form of open application programming interface (API), really simple syndication (RSS), extensible markup language (XML), JavaScript object notation (JSON), and the like.

The user data modeling unit 324 may be a part that figures out the user's personal preference. It may be a part of modeling user data through user's content consumption pattern, survey data, etc., and may be used to provide personalized content recommendation services in advance.

The vehicle situation recognition unit 330 may be a unit that recognizes a vehicle situation using information obtained through a vehicle sensor data modeling unit, a web data modeling unit, and a destination data modeling unit.

It may perform vehicle situational awareness, such as recognizing unpredicted rain through the vehicle's rain sensor, recognizing that the traffic flow is not smooth by combining the vehicle's speed data and traffic congestion data, or moving to the destination and predicting that the destination will have break time at the expected arrival time while moving to the destination.

The POI content recommendation unit 340 may be configured to recommend POI data related to the user data and vehicle route data or location-based POI data and re-recommend alternative POI data re-searched based on the changed data when any one or more of the user data, destination data, and vehicle sensor data is changed.

For example, when unpredicted rain is detected while moving to an outdoor destination, destinations with indoor activities may be recommended, or when traffic congestion doubles travel time, nearby destinations worth stopping by may be recommended.

When business is closed or a break time is taken at the expected arrival time at the destination, other nearby destinations may be recommended. The content may be POI-related content such as audios, images, and videos or media content such as music, movie, and drama. At this time, the recommended content may be provided customized to personal preference.

For reference, the POI content recommendation unit 350 may recommend a POI based on modeling data in preference to user information. It may also recommend POI content customized to features or POI content that may be of interest to the user based on user data.

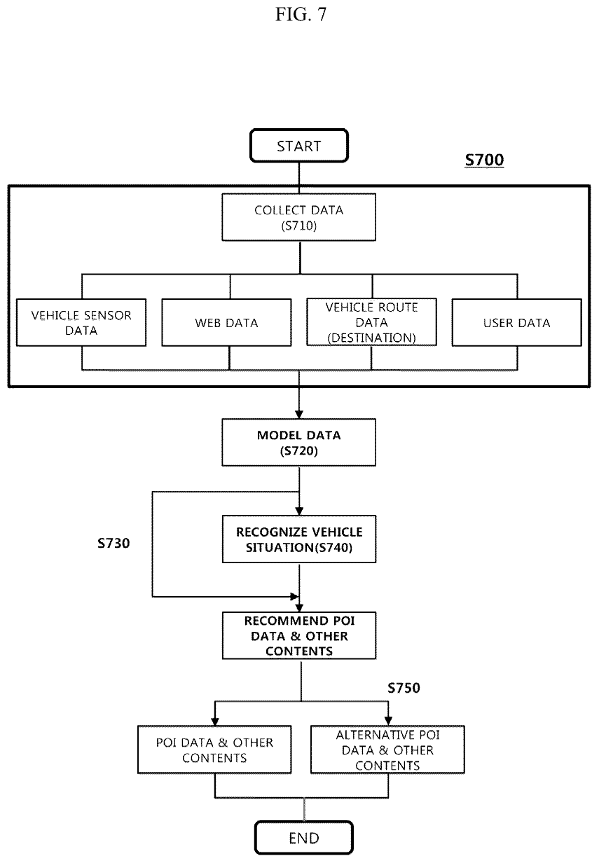

FIG. 7 is a flowchart illustrating a system for supporting service for recommending content based on vehicle situation recognition according to an embodiment of the present disclosure.

Referring to FIG. 7, in a method S700 of supporting an alternative content recommendation service based on vehicle situation recognition according to an embodiment of the present disclosure, first the data input unit 310 may collect user data and vehicle movement route data from a user terminal, vehicle sensor data from a vehicle terminal, and web data from a web server S710.

Afterwards, if the user data, vehicle sensing data, web data, and movement route data collected by the data modeling unit 320 are modeled S720, the POI content recommendation unit 340 may recommend POI data and other contents such as videos, music, and images suitable for the movement route such as destination data and user data S730.

Thereafter, the vehicle situation recognition unit 330 determines or recognizes the vehicle situation in real time based on the modeling data S740. When the vehicle situation changes, alternative POI data and/or other contents such as videos, music, and images to replace the POI data and/or other contents such as videos, music, and images may be searched for and re-recommended S750.

Further, step of S720 may comprise a process of modeling vehicle information including vehicle speed, location, direction, and temperature collected or measured by the user terminal, a process of collecting and modeling basic information and feature information related to a destination in the vehicle route data, a process of collecting and modeling web data including at least one of weather, traffic conditions such as traffic congestion, and local events in a region corresponding to the vehicle route, and a process of analyzing and modeling a user's individual preference based on user data received from the user terminal.

Step of S740 may be a process of recognizing the vehicle situation using the information obtained from the vehicle situation recognition unit 330 through the vehicle sensor data modeling unit, the web data modeling unit, and the destination data modeling unit. For example, the vehicle situation may be recognized such as recognizing unpredicted rain through the vehicle's rain sensor, recognizing that traffic flow is not smooth by combining vehicle speed data and traffic congestion data, or predicting that the destination has a break time at the expected arrival time while moving to the destination.

Step of S750 may be a process that re-recommends alternative POI data re-searched based on the changed data when any one or more of the user data, destination data, and vehicle sensor data is changed in a state in which the POI content recommendation unit 350 recommends POI data related to or location-based on the user data and vehicle route data.

For example, when unpredicted rain is detected while moving to an outdoor destination, destinations with indoor activities may be recommended, or when traffic congestion doubles travel time, nearby destinations worth stopping by may be recommended.

When business is closed or a break time is taken at the expected arrival time at the destination, other nearby destinations may be recommended. The content may be POI-related content such as audios, images, and videos or media content such as music, movie, and drama. At this time, the recommended content may be provided customized to personal preference.

For reference, the POI content recommendation unit 350 may recommend a POI based on modeling data in preference to user information. It may also recommend POI content customized to features or POI content that may be of interest to the user based on user data.

The system and method for recommending alternative content based on vehicle situation recognition according to an embodiment of the present disclosure provides customized contents according to the vehicle situation, such as the location, direction, destination, and movement speed of the vehicle, thereby having the advantage of being able to recommend customized alternative content according to the real-time changing vehicle movement situation and external variables.

The term “unit” used in one embodiment of the present disclosure may be implemented as a hardware component, a software component, and/or a combination of hardware components and software components. For example, devices and components described in the embodiments may be implemented using, for example, a processor, a controller, an arithmetic logic unit (ALU), a digital signal processor, a microcomputer, a field programmable array (FPA), or one or more general purpose or special purpose computers, such as any other device capable of executing and responding to instructions. The processing device may execute an operating system (OS) and one or more software applications running on the operating system. Further, the processing device may access, store, manipulate, process, and generate data in response to execution of software. For the convenience of understanding, there are cases in which one processing device is used, but those skilled in the art will understand that the processing device includes a plurality of processing elements and/or a plurality of types of processing elements. For example, a processing device may include a plurality of processors or a processor and a controller. It may also include other processing configurations, such as parallel processors.

Software may include a computer program, program code, instructions, or some combination thereof, for independently or collectively instructing or configuring a hardware device to operate as desired.

Software and/or data may be embodied permanently or temporarily in any type of machine, component, physical or virtual equipment, or computer storage medium or device, or transmitted signal wave capable of providing instructions or data to or being interpreted by a processing device. The software also may be distributed over network coupled computer systems so that the software is stored and executed in a distributed fashion. Software and data may be stored on one or more computer-readable media.

The method according to the embodiment of the present disclosure may be implemented in the form of program instructions that can be executed through various computer means and recorded in a computer-readable medium. The computer-readable recording medium may include program instructions, data files, data structures, etc. alone or in combination. Program instructions recorded on the medium may be those specially designed and configured for the present disclosure, or those known and usable to those skilled in the art of computer software. Examples of computer-readable recording media include magnetic media such as hard disks, floppy disks and magnetic tapes, optical recording media such as CD-ROMs and DVDs, and magneto-optical media such as floptical disks. Further, hardware devices are specially configured to store and execute program instructions, such as ROM, RAM, flash memory, and the like. Examples of program instructions include high-level language codes that can be executed by a computer using an interpreter or the like as well as machine language codes generated by a compiler. The hardware device may be configured to act as one or more software modules to perform operations according to the present disclosure and vice versa.

The contents described above may be modified and changed by those skilled in the art without departing from the essential characteristics of the present disclosure. Therefore, the present disclosure is not intended to limit the technical idea of the present embodiment, but to explain, and the scope of the technical idea of the present disclosure is not limited by these embodiments. The scope of protection of the present disclosure should be interpreted according to the claims below, and all technical ideas within the scope equivalent thereto should be construed as being included in the scope of rights of the present disclosure.

What is claimed is:

1. A system for recommending alternative content based on vehicle situation recognition, the system comprising:
a user terminal configured to provide user data and vehicle movement route data;
a vehicle terminal configured to provide vehicle sensor data; and
a point of interest (POI) data and content providing server configured to recommend POI data and/or other contents such as videos, music, and images, that is related to or location-based on at least one of the user data and vehicle movement route data provided from the user terminal, and the vehicle sensor data provided from the vehicle terminal, and web data collected from a web server, and recognize the vehicle situation according to changes in at least one of the user data, the vehicle movement route data such as destination, the vehicle sensor data, and the web data to re-recommend alternative POI data and/or other contents such as videos, music, and images, that is associated with at least one of changed data, wherein the user terminal is interlocked or mounted in the vehicle terminal.

2. The system of claim 1, wherein the POI data and content providing server collects vehicle information including vehicle speed, location, direction, and temperature collected or measured by the vehicle terminal and performs data modeling.

3. The system of claim 1, wherein the POI data and content providing server collects basic information and feature information related to a destination in the vehicle movement route data to perform data modeling.

4. The system of claim 1, wherein the POI data and content providing server collects web data including at least one of weather, traffic conditions such as traffic congestion, and local events in a region corresponding to a movement route of the vehicle to perform data modeling.

5. The A system of claim 1, wherein the POI data and content providing server models user data to analyze individual user preferences based on the user data received from the user terminal.

6. The system of claim 1, wherein the POI data and content providing server recognizes a change in vehicle situation in real-time based on the vehicle sensor data and the web data.

7. The system of claim 6, wherein the POI data and content providing server recommends an alternative content corresponding to or related to the user data, the movement route data such as destination, and the web data whenever the vehicle situation changes.

8. A method for recommending alternative content based on vehicle situation recognition, the method comprising:
collecting user data and vehicle movement route data from a user terminal, vehicle sensor data from a vehicle terminal, and web data from a web server;
modeling the user data, the vehicle sensor data, the web data, and movement route data collected from a POI data and content providing server;
recommending POI data and other contents such as videos, music, and images suitable for the vehicle movement route data such as destination and user data;
determining or recognizing the vehicle situation in real time based on the modeling data; and
searching for and re-commending alternative POI data and/or other contents such as videos, music, and images to replace the POI data and/or other contents such as videos, music, and images when the vehicle situation changes.

9. The method of claim 8, wherein the modeling is performed by modeling vehicle information including vehicle speed, location, direction, and temperature collected or measured by the vehicle terminal;
collecting and modeling basic information and feature information related to the destination in the movement route data;
collecting and modeling web data including at least one of weather, traffic conditions such as traffic congestion, and local events in a region corresponding to the movement route; and
analyzing and modeling the user's individual preference based on the user data received from the user terminal.
